(19) United States
(12) Patent Application Publication
(10) Pub. No.: US 2017/0240220 A1
(43) Pub. Date: Aug. 24, 2017

(54) Vehicle Fairing with Brake Cooling System

(71) Applicants: Steven Kron, Pewaukee, WI (US); Eric Thomas Kron, Pewaukee, WI (US)

(72) Inventors: Steven Kron, Pewaukee, WI (US); Eric Thomas Kron, Pewaukee, WI (US)

(21) Appl. No.: 14/031,042

(22) Filed: Sep. 18, 2013

(51) Int. Cl. B62D 35/00; F15D 1/00; B62D 63/08; B60T 5/00; B62D 35/02

(52) U.S. Cl. CPC B62D 35/001; B60T 5/00; B62D 35/02; B62D 63/08; F15D 1/009; B60Y 2400/408

(57) ABSTRACT

The primary purpose of this device is to reduce the fuel consumption of heavy trucks by improving airflow along the underside of a trailer, by way of a fairing mounted forward of the axles. This fairing is a teardrop shaped wedge with a flat bottom surface, which directs air towards the sides of the vehicle, while allowing a smaller volume to flow beneath the fairing such that it will clear the axles. Each axle is also covered by a flat panel, such that air will continue to travel smoothly beneath them. Attached to each panel is a brake cooling system, which consists of a pair of panels protruding downward, with their surfaces parallel to the direction of airflow. When the brakes are engaged, these panels rotate towards the center in an angled configuration, which redirects air towards the drums during and after braking, cooling them quickly and efficiently.

### BACKGROUND OF THE INVENTION

Of the factors influencing the fuel economy of semi-trucks, aerodynamics is the field in which the greatest improvements might be most readily made. Of the two types of aerodynamic drag, friction drag and pressure drag, pressure drag has a particularly significant impact on heavy trucks, accounting for as much as 90% of drag force. On a standard, unmodified truck and trailer, approximately one third of this pressure drag is caused by the vehicle undercarriage.

When the elements which cause drag are essential structural components, they cannot be removed, displaced, or dramatically altered. Instead, aerodynamic fairings can be attached to the vehicle to improve airflow, thereby reducing drag and consequently fuel consumption.

In particular, the axles and associated parts of the undercarriage are prohibitive to smooth, stable airflow. A fairing installed forward of the tires can prevent most air from ever reaching the axles, minimizing related turbulence and improving aerodynamic efficiency. However, if the air that would otherwise be swirling about the axles is instead redirected towards the sides of the vehicle, then substantially less air is flowing past the brakes. Without the cooling effect of this airflow, the brakes may become ineffectively and dangerously hot.

### SUMMARY OF THE INVENTION

The invention consists of a fairing mounted to the underside of a trailer and a brake cooling system attached to both axles. The basic shape of the fairing is a wedge that spans the full width of the trailer, which curves towards the outside edge and tapers to a flat surface parallel to the sides of the trailer. There are two vertical panels that form this teardrop contour, meeting at the central axis of the trailer and extending outwards, such that they direct air towards the sides of the vehicle.

The bottom is fully enclosed, with horizontal panels forming a flat, smooth surface. These horizontal panels extend forward of the vertical panels, to create a horizontal splitter. While the vertical panels are contoured to redirect air smoothly towards the sides of the vehicle, the horizontal splitter neatly separates the mass of air into an upper and lower volume. This minimizes turbulence and prevents air that is above the splitter from being forced down beneath the fairing.

As the fairing is composed of separate panels, it can be configured to fit around toolboxes and other storage units installed on the underside of the trailer. When such storage units are present, the panel configuration is adapted to include these boxes so that they are integral to the fairing, wherein they may act as a sidewall and bottom surface.

Either in back of these boxes or directly behind the main body of the fairing, additional panels comprise an aft section, which angles downward to a terminating edge that is lower than the height of the axle, such that the lower air volume is confined below. The rear side panels extend backwards to the tires, with a semicircular cutout, such that the panel and tires do not overlap. The rear bottom panel angles downward from the main body of the fairing and is curved such that trailing surface is parallel to the ground. Low drag vortex generators are placed along the trailing edge so that the air will continue to flow smoothly past the axles.

Each axle is also covered by a flat panel, such that this volume of air is confined to the space beneath. A brake cooling system is mounted to both of these panels, and is comprised of a pair of rotating panels, which protrude downward such that their surfaces are parallel to the direction of the airflow. When the brakes are engaged, these panels rotate towards the center in an angled configuration, which redirects air towards the drums during and after braking to cool them quickly and efficiently. While the total volume of air flowing past the axles is reduced by more than half, the remaining volume is funneled directly towards the brakes, so the cooling effect of the air is at least comparable to instances where no such fairing is installed.

The mechanism by which these panels are rotated from an undeployed to a deployed configuration consists of a pneumatic cylinder rotatably attached on both sides to a lever, which is fixedly attached to a rod extending through a bearing, wherein the rod is connected to one of these panels. When the piston retracts, the panels rotate into position, and they return to their undeployed configuration as it is extended.

As the cooling mechanism redirects airflow towards the brakes, when the first pair of panels is deployed, it obstructs airflow to the second pair. As such, the forward cooling mechanism is disengaged prior to the rearward one, so that both of these mechanisms may have the same effect. The deployment of these panels is electronically controlled, either by manual input or a computerized system.

### BRIEF DESCRIPTION OF THE DRAWINGS

FIG. 1. Perspective view of the underside of a semi-trailer with the fairing and brake cooling system installed.

FIG. 2a. Passenger side view of the fairing, showing the wheels and a segment of the siderail.

FIG. 2b. Bottom view of the fairing with the brake cooling system deployed.

FIG. 3. Perspective view from underneath the fairing, with the brake cooling system deployed.

FIG. 4. Perspective view from underneath the fairing, with the brake cooling system undeployed.

FIG. 5. The fairing as viewed from above, with the brake cooling system in the deployed configuration.

FIG. 6. The fairing as viewed from above and from the rear, on the driver side.

FIG. 7a. The underside of brake cooling system attached to the axles and in the undeployed configuration.

FIG. 7b. The topside of the brake cooling system installed on the axles, in the deployed configuration.

FIG. 8a. The brake cooling systems and air cylinder mechanism in the undeployed configuration.

FIG. 8b. The brake cooling systems and air cylinder mechanism in the deployed configuration.

FIG. 9. Top view of the brake cooling system in both the undeployed and deployed position.

FIG. 10a. A view from directly underneath the fairing, showing the brake cooling system in the undeployed position.

FIG. 10b. A view from directly underneath the fairing, showing the brake cooling system in the deployed position.

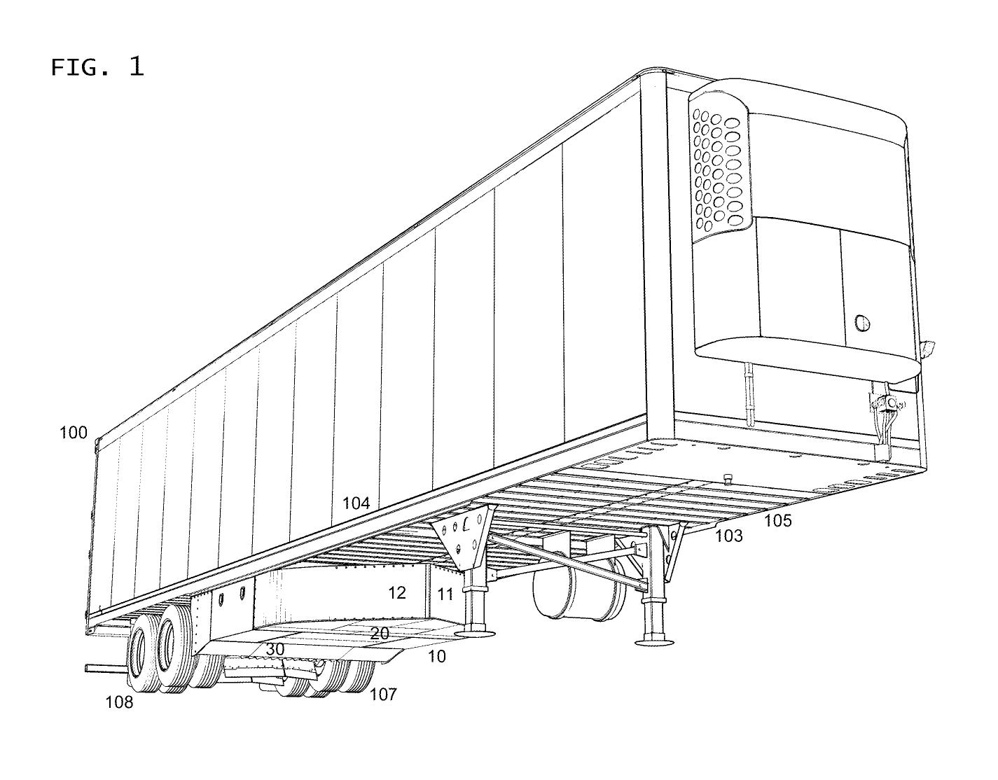

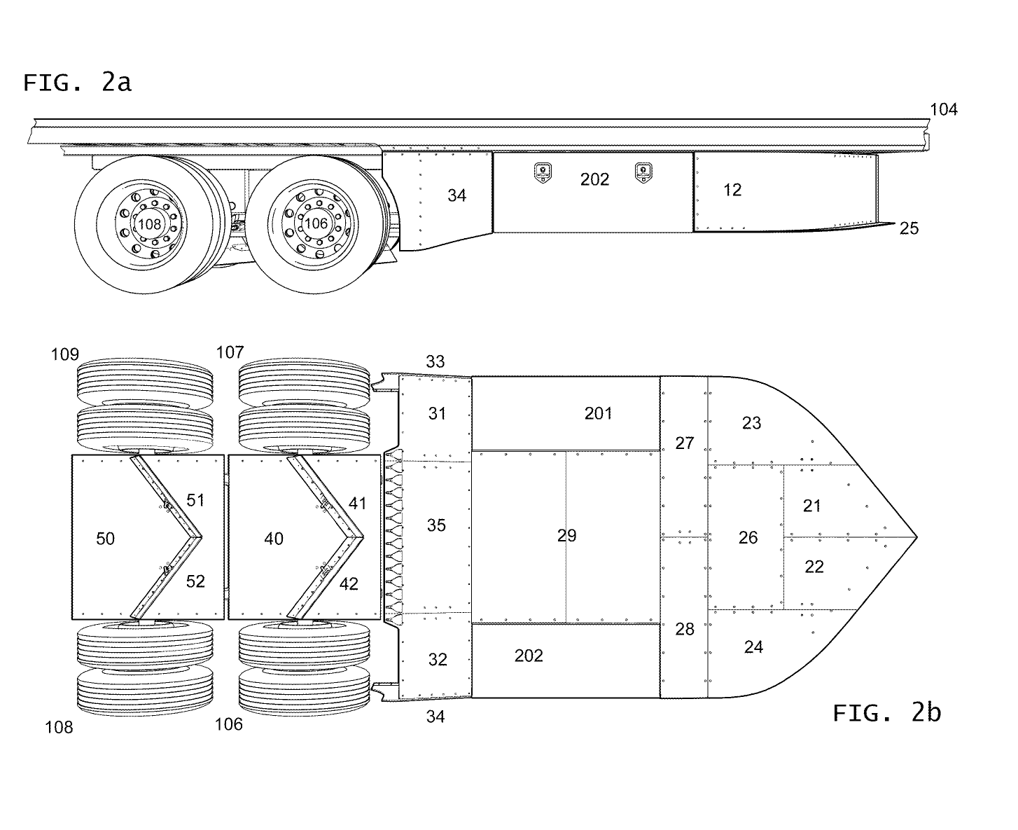

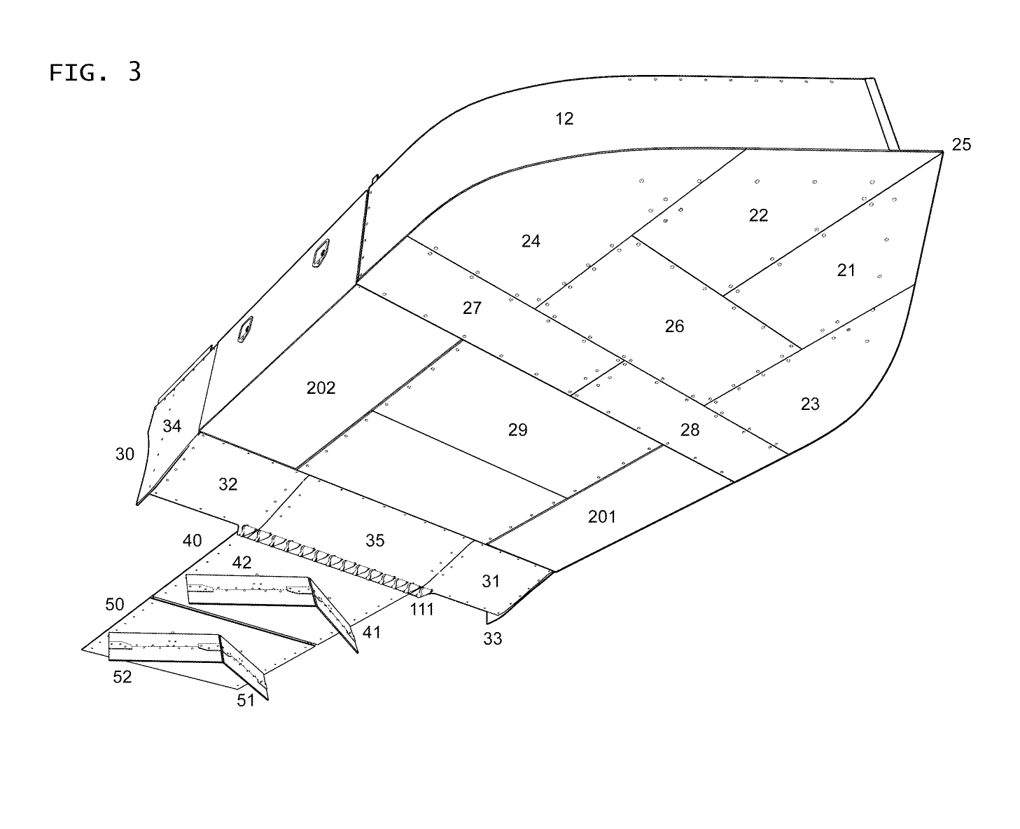

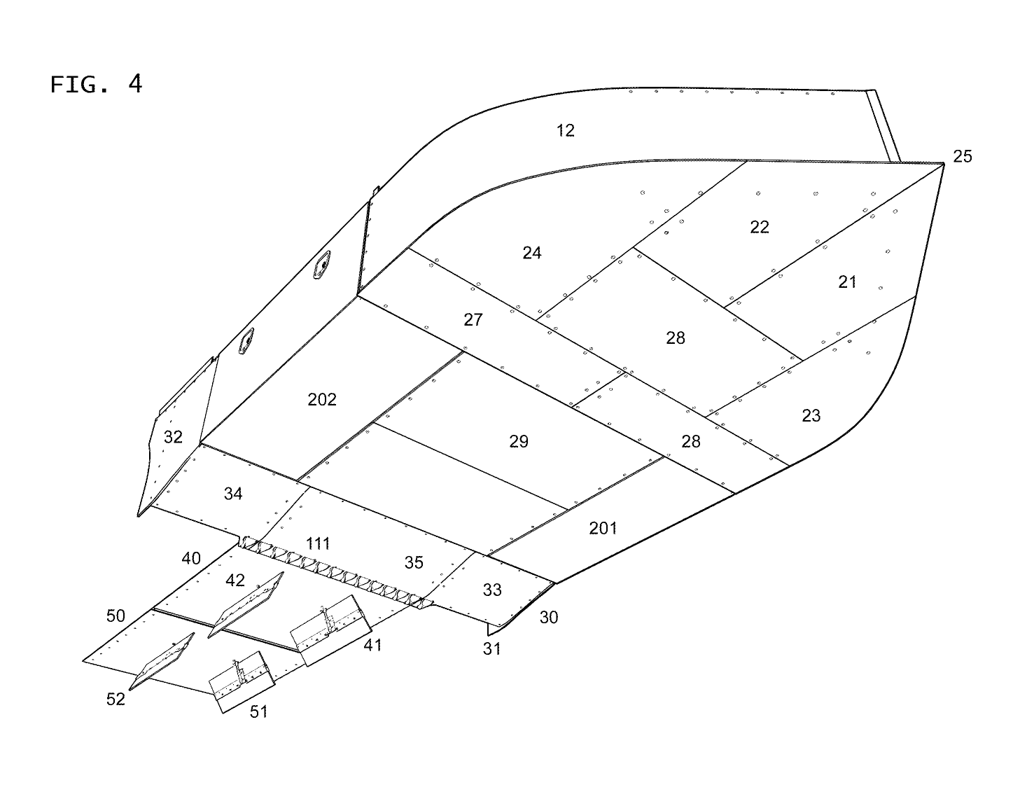

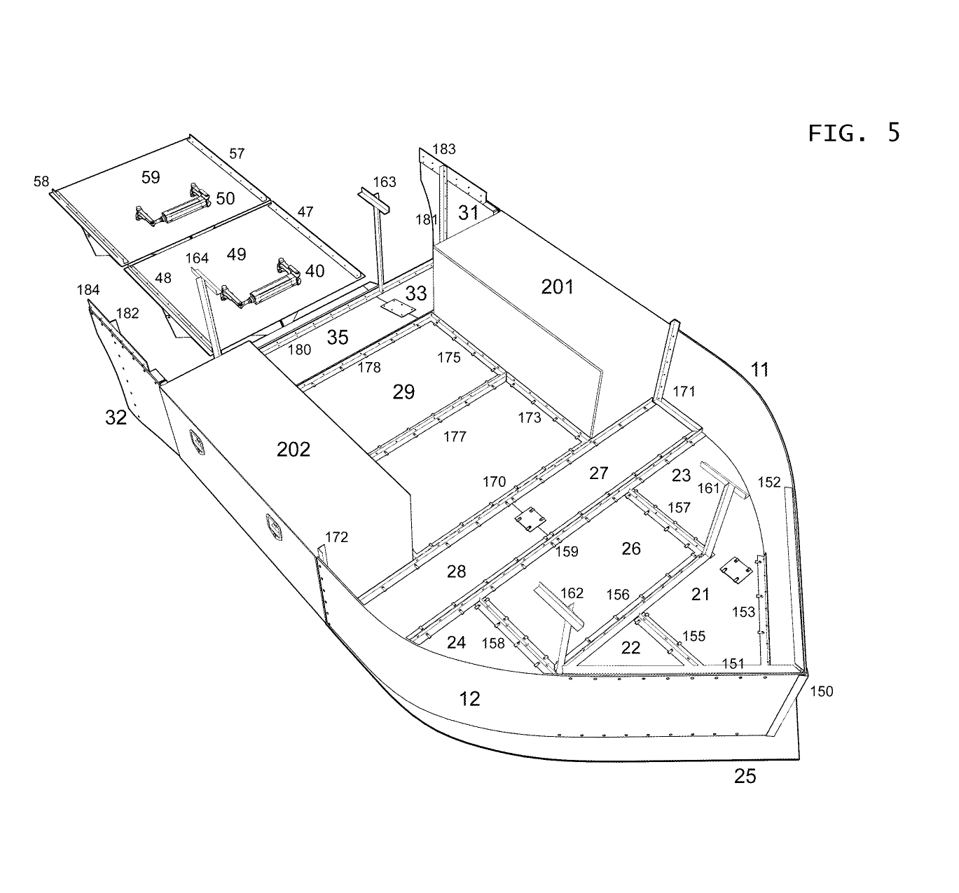

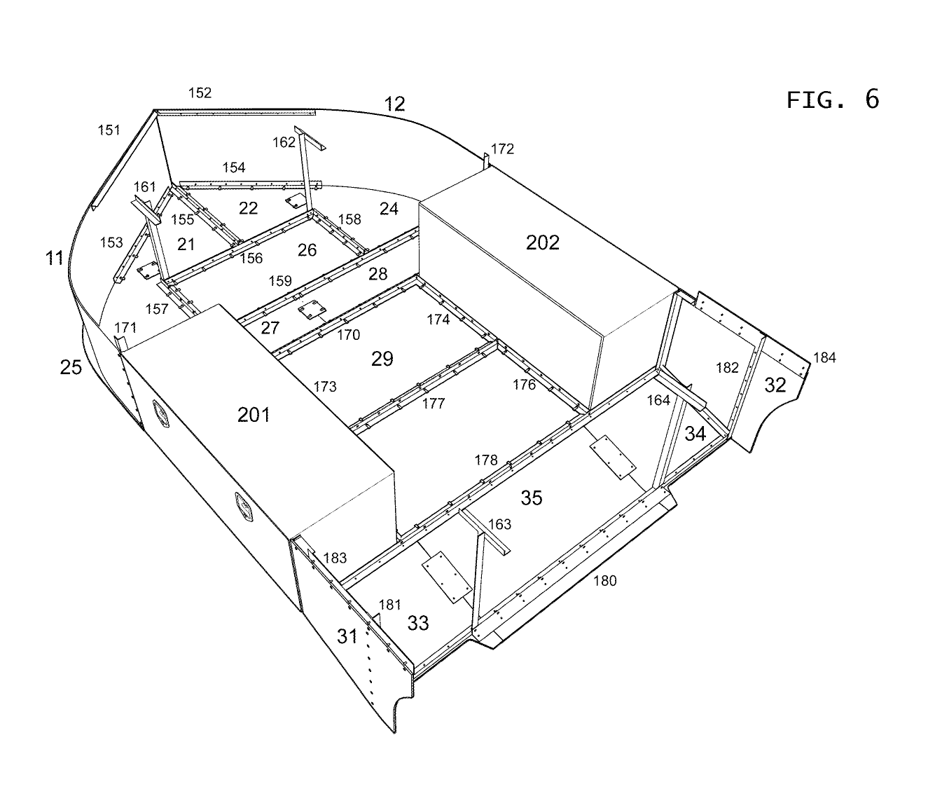

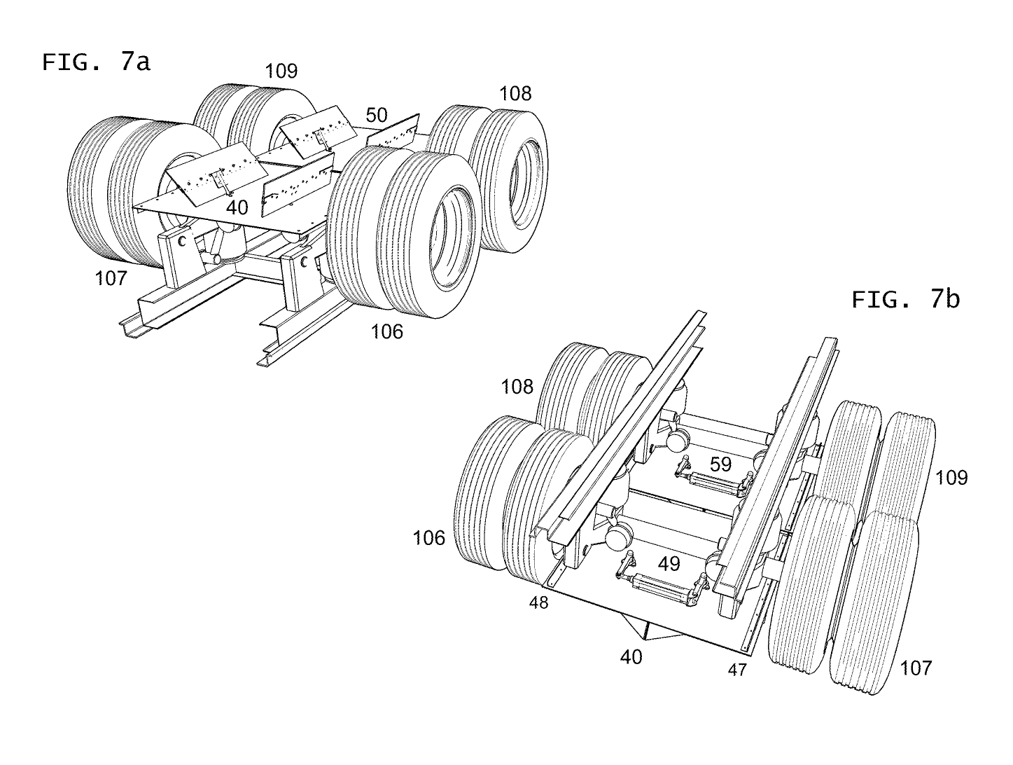

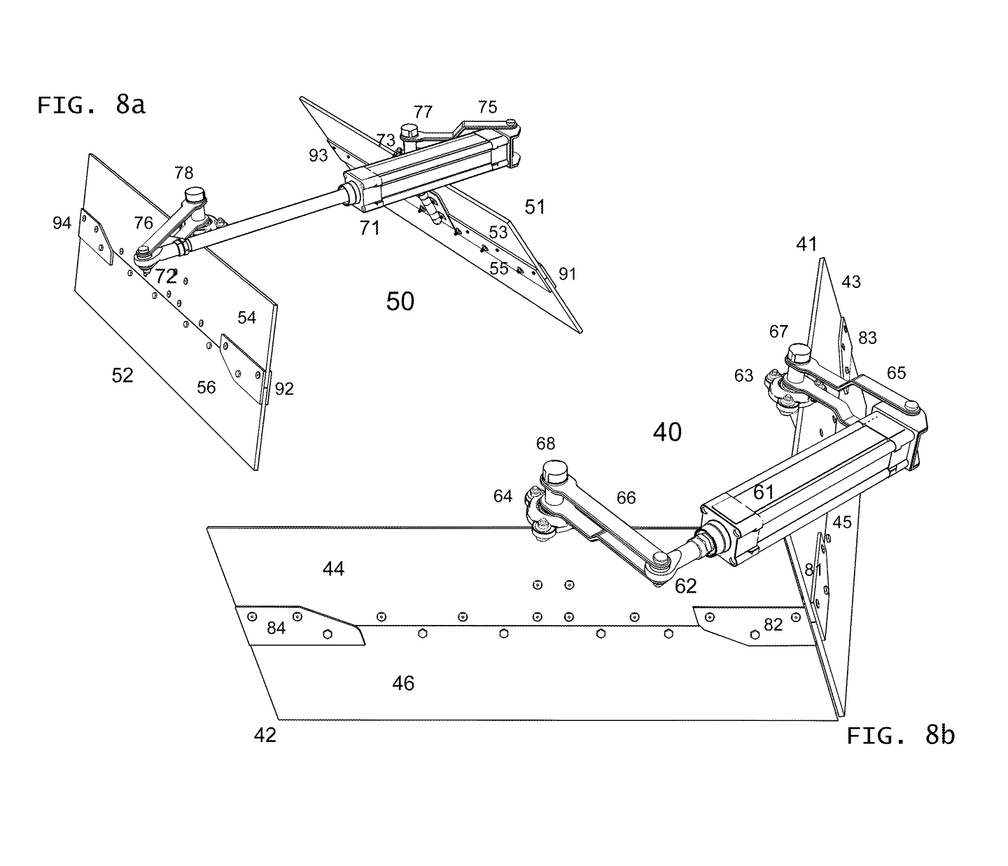

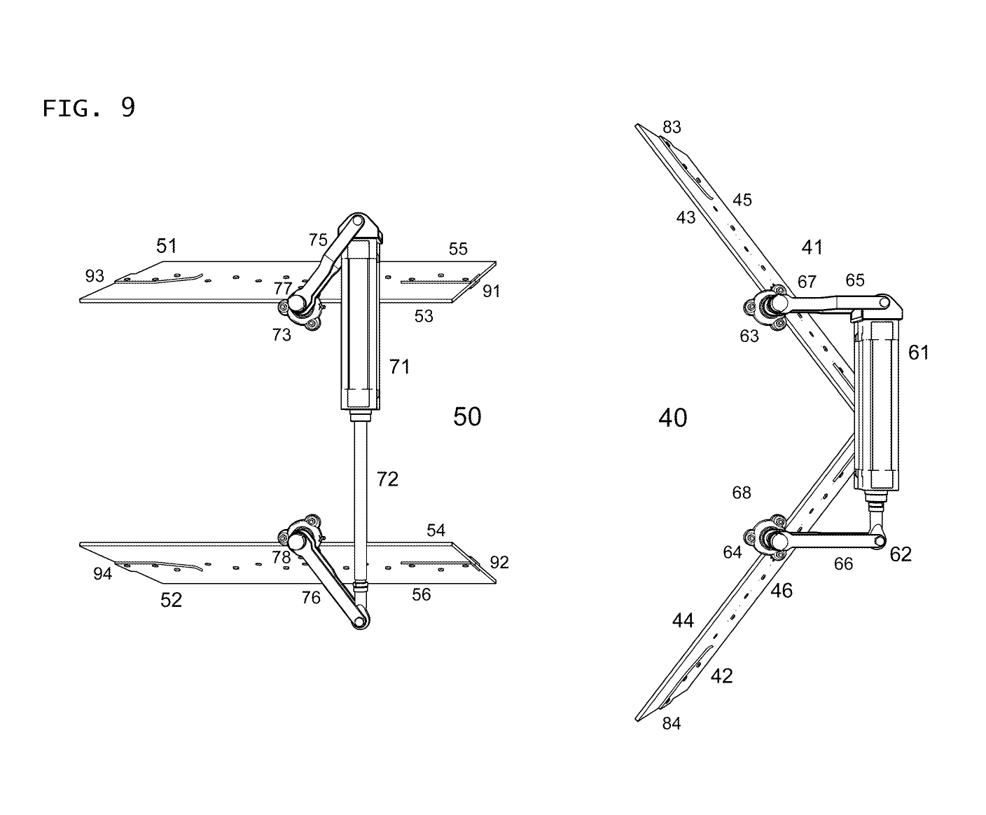

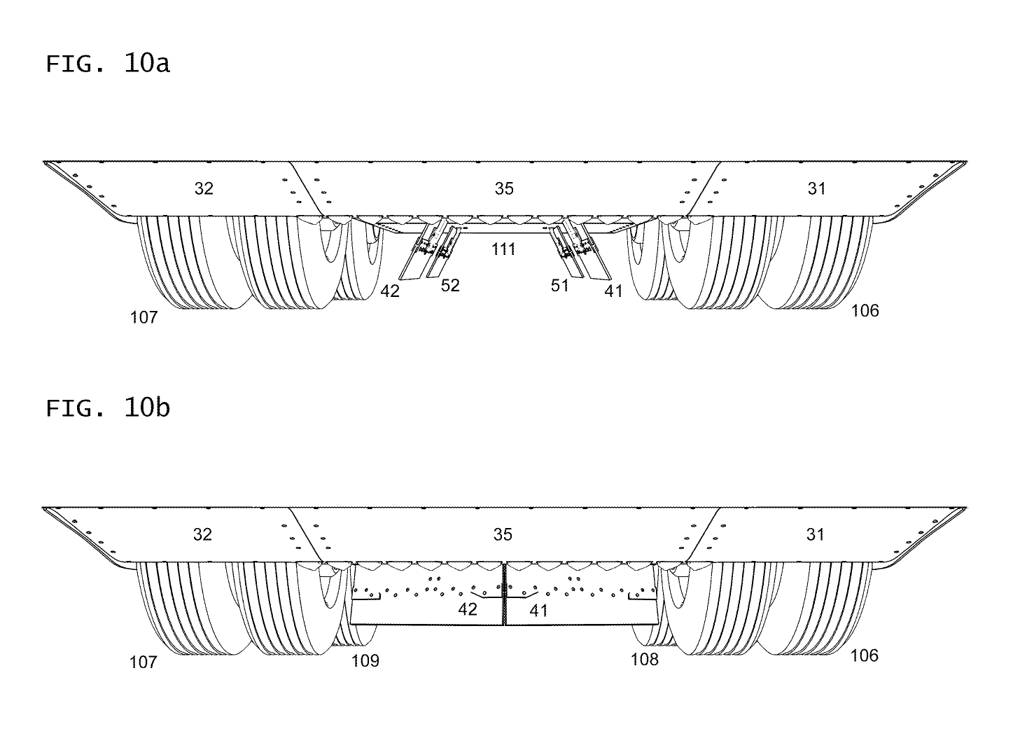

### DETAILED DESCRIPTION OF THE PREFERRED EMBODIMENT

The invention consists of fairing 10 mounted to the underside of a trailer and brake cooling systems 40 and 50 attached to both axles. The basic shape of the fairing is a wedge that spans the full width of trailer 100, which curves towards the outside edge and tapers to a flat surface parallel to the sides of the trailer. In the exemplary embodiment, this teardrop shaped wedge is formed by directionally flexible fiberglass composite sheets 11 and 12, measuring eight feet by two feet. They are curved inward from the outer edge of the trailer and angled inwards so that they meet along their forward edges.

These sheets are joined along this edge by aluminum angle 150 and a series of rivets. Aluminum angles are also riveted to the inside of the sheet, with angles 151 and 152 along the top edge, through which panels 11 and 12 are attached to the underside of the trailer. Angles 153 and 154, which are riveted to the bottom edge, further define the curvature of panels 11 and 12 by forming an angled edge that is secured to horizontal panels 21, 22, 23, and 24. Aluminum supports are attached along only the straight edges of the sheet, and the curved edge of the panel is not directly attached to the trailer or otherwise reinforced. The curve results from the directionally flexible nature of the sheet and the overall shape imposed by the aluminum substructure.

This teardrop shaped wedge causes air to flow towards the outside of the vehicle, rather than underneath and through the undercarriage. As this will inevitably force some air up or down, it is important to cover the trailer crossmembers 105 around the fairing so that air forced upward does not cause unwanted turbulence. The panels that cover these fairings are cut to correspond with the size and shape of the area surrounding the fairing and fixedly attached to the crossmembers and siderails 103 and 104, minimizing turbulence by closing gaps and creating a flat surface that air will flow smoothly past.

As a high volume of air will also flow underneath fairing 10, the bottom is fully enclosed, with horizontal panels forming a flat, smooth surface. In the preferred embodiment, these panels are composed of the same durable, directionally flexible fiberglass composite sheets that comprises the sidewalls of the fairing, but other materials such as Kemlite may also be used. The bottom is segmented so that panels are easier to install and cheaper to replace. This also allows for the directionally flexible nature of the material to be fully taken advantage of, such that the pieces are more stable or resistant to damage, according to grain of the material.

These panels are attached to a metal framework comprised of aluminum angles, which is fixedly attached to crossmembers 105 using rivets, bolts, or clamps. Angles 161, 162, 163, and 164 are nested horizontally in between the crossmembers and attached to a vertical angle that extends downward to a base. The base of this framework consists of angle pairs that are riveted together. Holes are drilled at regular intervals through both angles, and rivets fasten them together along their vertical surfaces. The horizontal surfaces of the angles also have a series of holes and these are each fitted with a U nut, which allows for the panels to be bolted or unbolted even when access to the opposite side is restricted or otherwise obstructed. With a bolt driven through the panel and the U nut, the panels are secured to the aluminum angles.

These angle pairs fit around the seams between panels, with either angle on either side of the seam. In the exemplary embodiment, angle pair 155 joins panels 21 and 22, angle pair 156 joins panel 26 with 21 and 22, angle pair 157 joins panel 26 with 23, angle pair 158 joins panel 26 with 24, and angle pair 159 joins panels 23, 24, and 26 with 27 and 28.

In the exemplary embodiment, the surfaces of the fairing are assembled around a toolbox on either side of the trailer, such that angle pair 170 joins panels 27 and 28 to panel 29 and to toolboxes 201 and 202, but where there are no toolboxes present, panels 27 and 28 are joined directly to aft portion 30. Instead, angle 171 joins panel 11 with toolbox 201 and angle 172 joins panel 12 with toolbox 202. Panel 29 spans the gap between the toolboxes and is split into two smaller, more manageable segments that are joined together via angle pair 177, and to the toolboxes via angles 173, 174, 175, and 176.

Where there is a seam between the panels that is short enough that the panels do not require structural support, an additional piece of fiberglass composite will be sufficient to hold them together. This supplementary panel is drilled with holes and fitted with U nuts so that it may be bolted to the larger panels on either side of the seam.

The horizontal panels 21, 22, 23, and 24 extend forward of vertical panels 11 and 12 to form horizontal splitter 25, the extent of which may be as great as six inches to one foot while tapering to as little as one inch towards the sides of the trailer. While vertical panels 11 and 12 are contoured to redirect air smoothly towards the sides of the vehicle, the horizontal splitter neatly separates the mass of air into an upper and lower volume. This minimizes turbulence and prevents air that is above the splitter from being forced down beneath the fairing.

In the exemplary embodiment, the fairing is built around toolboxes 201 and 202, which measure five feet by two feet by two feet, that are mounted underneath the trailer on either side. Portions of the aluminum support structure are attached directly to the toolbox or the frame to which it is mounted. Panels 29 span the gap between the boxes to form a continuous flat surface.

Either in back of these boxes 201 and 202 or directly behind the main body of fairing 10, additional panels comprise an aft section, which angles downward to a terminating edge that is lower than the height of the axles, such that the lower air volume directed below them. The rear side panels 31 and 32 extend backwards to tires 106 and 107, and each has a semicircular cutout such that the panel and tires do not overlap. The rear bottom panels 33, 34, and 35 angle downward from panel 29 and the main body of the fairing.

For rear side panels 31 and 32, an aluminum framework is attached at or near the edge of the cutout. Aluminum frames 181 and 182 are attached to aluminum panels 183 and 184, respectively, which when riveted to the trailer siderail provide aft section 30 a secure mounting surface. This framework also supports crossbar 180, an aluminum angle that extends the width of the trailer and to which the rear bottom panels are attached attached. This crossbar is paired with an aluminum angle that spans the distance between the tires are which as a wide bottom surface onto which the central bottom panel is curved and fixedly attached using rivets. While panel 35 is angled downward, the trailing surface of this central rear panel is parallel to the ground, such that it provides a mounting surface for low drag vortex generators 111, which cause the air to flow smoothly past the axles.

While aft portion 30 of fairing 10 tapers down from a height at or above that of the axles to a height below them, the entire fairing could be built to the lower clearance. However, this would add weight, increase materials cost, and heighten chance of damage. Furthermore, a higher main body with an aft section that angles downward will cause more air to flow past the axles, as the air is compressed from a greater volume, thus better serving the disclosed brake cooling system.

So that the lower air volume remains confined to the space beneath the axles, a horizontal panel is attached independently to each axle, effectively extending the bottom surface of the fairing. These panels 49 and 59 are attached to the axel via U clamps that fit around it on either side. They are composed of the same directionally flexible fiberglass used throughout the main fairing, and reinforced by aluminum angles 47 and 57 along the left edge along with 48 and 58 on the right edge, such that the panel remains flat and does not continually flex or bend. It is essential that panels 49 and 59 remain substantially flat, such that brake cooling mechanisms 40 and 50 can operate fluidly and without making contact with these panels.

These panels also serve as a mounting surface for brake cooling mechanisms 40 and 50, which directs the lower air volume towards the brake drums of wheels 106, 107, 108, and 109. The first brake cooling mechanism 40 is comprised of two flat panels 41 and 42 which protrude down towards the ground. The second brake cooling mechanism 50 is comprised of flat panels 51 and 52. In the undeployed position, these panels are oriented straight forward, their surfaces parallel to the movement of the vehicle and to the direction of the airflow. When deployed, these panels rotate towards the center, where they meet to form an angled configuration that intersects the lower airflow volume and directs it towards the brakes for a cooling effect.

The panels, which are comprised of several pieces that form a substantially flat surface, extend downward at an angle such that they form an incline when rotated into the deployed position. Each panel is in the shape of a parallelogram, such that its acute angles are equivalent to the angle at which the panel extends downward. The panel can be divided lengthwise down the middle, between upper segments 43, 44, 53, and 54 consisting of a semi-rigid panel and lower segments 45, 46, 55, and 56 consisting of a flexible sheet. This semi-rigid panel is composed of the same directionally flexible fiberglass composite as all of the other panels, while the flexible sheet is comprised of a rubber sheet or belting. They are held together by supplementary pairs 81, 82, 83, and 84 (in the instance of the first brake cooling mechanism 40) and pairs 91, 92, 93, and 94 (in the instance of the second brake cooling mechanism 50) attached to either side of both the upper and lower segments using bolts or rivets.

As the panel has very low ground clearance, it may sometimes be necessary or advantageous to remove bottom segments 45, 46, 55, and 56 such that the panels are less susceptible to collision and damage. So that they can be easily removed, they should be attached to the upper segment using bolts instead of rivets. If the flexible sheet is attached via rivets, they should not be reinforced by a backing plate, as to allow piece to more easily break away and prevent greater damage.

The most common situation where it may be desirable to remove the flexible piece comprising the lower segment of each rotating panel is when travelling through deep snow. However, the much lower temperatures of such an environment greatly reduce the usefulness of the cooling mechanism, so the device may instead be deactivated. When the brake cooling mechanism is undeployed, panels 41, 42, 51, and 52 are oriented in the same direction that the vehicle is traveling and consequently should be able to pass through deep snow or drifts with little resistance.

As cooling mechanisms 40 and 50 redirect airflow towards the brakes, when the first pair of panels 41 and 42 is deployed, it obstructs airflow to the second pair 51 and 52. As such, forward cooling mechanism 40 is disengaged prior to rearward mechanism 50, so that both of these mechanisms may have the same effect. The deployment of these panels is electronically controlled, either by manual input or a computerized system.

The mechanism by which these panels are rotated from an undeployed to a deployed configuration consists of a double-acting pneumatic cylinder, which us rotatably attached on either side to a lever. In instance of the first cooling mechanism, pneumatic cylinder 61 is rotatably attached to levers 65 on the left via a pin and levers 66 on the right via rod end bearing 62. These levers are fixedly attached to a rod that extends through pillow block bearings 63 and 64 and which is secured to one of the rotating panels 41 and 42.

In instance of the second cooling mechanism, pneumatic cylinder 71 is rotatably attached to levers 75 on the left via a pin and levers 76 on the right via rod end bearing 72. These levers are fixedly attached to a rod that extends through pillow block bearings 73 and 74 and which is secured to one of the rotating panels 51 and 52.

When the cylinder retracts, it pulls the levers inward and rotates the panels into a deployed configuration. The panels return to their undeployed configuration as the cylinder and the piston rod extend and push the levers outward. If the cylinder is positioned aft of the their pivot points, the relationship is reversed, such that the panels are deployed when the cylinder is extended and undeployed when it is retracted. Either configuration is feasible and may be employed as necessary.

This whole assembly rests on a pair of pillow block bearings, which are attached to the upper surface of the axle panel. A rod extends through the bearing to the underside of the axel panel, where it is fixedly attached to the rotating panel. Wherein the rod extends through the bearing, it is perpendicular to the axel panel. Wherein the rod is attached to the rotating panel, it is bent such that this panel is mounted at an angle and the rod is parallel to the surface of the panel.

A lever is fixedly attached to this rod and rotatably attached to the cylinder. Both levers are comprised of a top and bottom piece, which helps to support the cylinder and ensure that the panels rotate uniformly along a designated axis, rather than loosely about a single point. The lever is secured by an end cap that is screwed or welded onto the top of each rod, which in conjunction with the lever further holds the entire assembly place by preventing the rod from sliding up or down. In the instance of the first cooling mechanism, levers 65 are secured by end cap 67 and levers 66 are secured by end cap 68. In the instance of the first cooling mechanism, levers 75 are secured by end cap 77 and levers 76 are secured by end cap 78.

The levers are functionally symmetrical, but are attached to the cylinder in different ways. On the one side, the piston rod is capped with a rod end bearing 62, and lever 66 is attached through the rod end with a bolt. While lever 66 is fixedly attached to the bearing, the bearing rotates freely, such that the rod end is the pivot point for this lever. On the other side, a fixture is attached to the end of the cylinder, wherein this fixture has a upper and lower surface, each with an aperture in line for a pin. The lever is attached via the pin and rotates about its axis. As this lever rotates towards the cylinder, it must clear the cylinder on both the top and bottom and it is contoured to create a sufficient gap between the inside surface of the fixture and the outer surface of cylinder 61.

The cylinder is connected to the trailer's built in air supply. As it is a double-acting cylinder there is an inlet and an outlet on either end, so that pumping in air to one side causes the cylinder to extend and on the other end it causes the cylinder to retract. A hose runs from both inlets to the air supply, and air is pumped into one or the other according to an electronic signal sent by the deployment control system.

What is claimed is:

1. An undermounted fairing comprised of two curved side panels that form a teardrop shaped wedge and a plurality of bottom panels that form a flat surface.

2. The undermounted fairing of claim 1, wherein said bottom panels protrude forward of said side panels to form a horizontal splitter, which divides the mass of incoming air into an upper air volume and a lower air volume, wherein said lower air volume is between the surface of the road and the underside of fairing.

3. The undermounted fairing of claim 1, wherein said fairing is further comprised of two rear side panels and at least one rear bottom panel and said rear panels angle downward to a terminating edge that is lower than the height of the axle.

4. The at least one rear bottom panel of claim 3, wherein low drag vortex generators are attached to the underside of said rear bottom panel.

5. A brake cooling system consisting of:
a horizontal panel attached to an axle;
a pair of rotating panels rotatably attached to said horizontal panel;
wherein said rotating panels have a deployed position and an undeployed position;
wherein said undeployed position said rotating panels are parallel to the vector of said lower airflow volume;
and wherein said deployed configuration, said rotating panels are angled towards the center of the vehicle and intersect said lower airflow volume, forming an airflow channel directed towards the brakes on either side of the deployed configuration.

6. The brake cooling system of claim 5, wherein said rotating panels are attached to a deployment mechanism consisting of:
two rods, wherein each of said rods are fixedly attached to one of said rotating panels;
two levers, wherein each of said levers are fixedly attached to one of said rods;
and a pneumatic cylinder, wherein said pneumatic cylinder is rotatably attached to both of said levers

7. The deployment mechanism of claim 6, wherein said deployment mechanism is rotatably attached to said horizontal panel through a bearing.

8. The deployment mechanism of claim 6, wherein said pneumatic cylinder is connected to the vehicle's built in air supply.

9. The brake cooling system of claim 5, wherein said rotating panels are angled between 90 and 45 degrees relative to the bottom surface of said horizontal panel.

10. The brake cooling system of claim 5, wherein said rotating panels are comprised of a semi-rigid panel and a flexible sheet.

11. The brake cooling system of claim 5, wherein a first brake cooling system is mounted to the front axle and a second brake cooling system is mounted to the rear axle.
